(19) United States
(12) Patent Application Publication
(10) Pub. No.: US 2014/0236932 A1
(43) Pub. Date: Aug. 21, 2014

(54) INFORMATION SEARCH DEVICE

(71) Applicant: Artashes Valeryevich Ikonomov, Moscow (RU)

(72) Inventor: Artashes Valeryevich Ikonomov, Moscow (RU)

(21) Appl. No.: 14/347,201

(22) PCT Filed: Jul. 23, 2012
(86) PCT No.: PCT/RU2012/000598

§ 371 Date: Mar. 25, 2014

(30) Foreign Application Priority Data
Nov. 22, 2011 (RU) 2011147159

(51) Int. Cl. G06F 17/30

(52) U.S. Cl. CPC G06F 17/30554
USPC 707/722

(57) ABSTRACT

This utility model relates to systems for implementing a search for information relating to items of interest to a user.

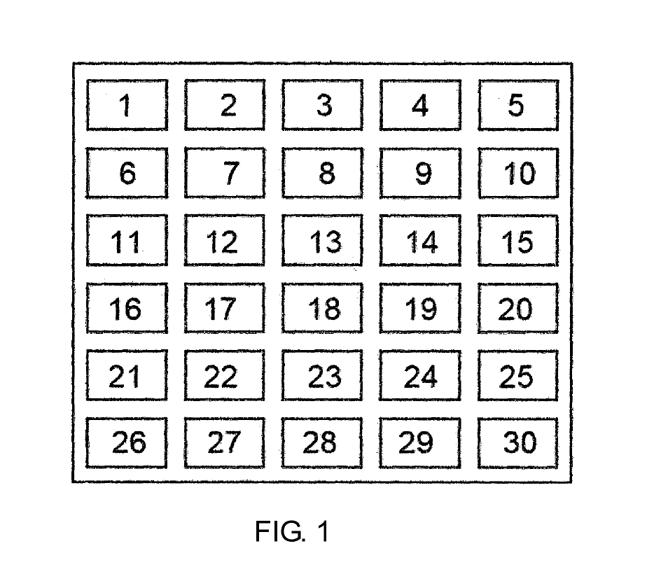

The problem addressed by the proposed utility model consists in increasing the speed of an information search.

This utility model is implemented in the following way. Therefore, forming a device from the units described here ensures an increase in the speed of the information search by virtue of presenting information at each point in time in the form of an information display corresponding to a predetermined level of classification of information and limitation of the quantity of said information which is subject to processing by the system without any loss of search quality.

### TECHNICAL FIELD

The utility model relates to systems for implementing a search for information relating to objects of interest to a user.

### PRIOR ART

It is known a technical solution, i.e. a Yandex object search system (http://maps.yandex.ru/?text). The Yandex object search system comprises an object data memory module, a geographical data memory module, an object selection module by means of a selection filter, a module of object positioning on the screen, an object data deletion module, a new object data entry module, a selected object data storage module, an object contact information storage module. The Yandex object search system is built so as to search data from among the objects stored in the object data memory module with the help of the object selection module by means of a selection filter. In this way the filtered objects are positioned on the map of the area included in the search (e.g. a city or a country) using the module object positioning on the screen. As soon as one of the object is selected, the system visualizes the data for such object.

Low information search rate is the drawback of said known technical solution.

An objects search system with 2D/3D rendering (http://www.google.com/earth/index.html) is the closest technical solution (prototype). The 2D/3D rendering system is embedded in the object search system so as to render the planet in 3D to enable the user to rotate the planet and zoom specific fractions of said image in and out. The system also includes an option of visualizing waterways and continents disposed on the planet as the planet is zoomed in. As the continents are zoomed in, the system visualizes states and state borders. When one of the states is selected, cities are visualized. When a city is selected, its streets, squares and houses are visualized. Each of the above images may be rendered in 2D and/or 3D. A particular case of the planet visual representation is that of the planet Earth. The visual representation of said planet contains visual representations of the continents, states, cities, streets and buildings actually present on the planet Earth. If required, the user can locate, for example, a historical landmark or any other building/structure and view the same as rendered in 3D. Said rendering can also be maximized so that it could be easily viewed from all directions.

Low information search rate is the drawback of said prototype.

The utility model under study is directed towards an increased information search rate.

### DISCLOSURE OF THE INVENTION

The object in view is accomplished by the following solution: an information search device comprising a visualization module; an information input module; a target object memory module; a geographical data memory module; a module for the storage of images which are perceived by the user as the planet visual representation; a module for the storage of images which are perceived by the user as the token representation of states; a module for the storage of images which are perceived by the user as visual representations of cities; a module for the storage of images which are perceived by the user as visual representations of a city square; a module for the storage of images which are perceived by the user as visual representation of a street; a module for the storage of images which are perceived by the user as visual representation of a house; a module for filtering target objects by a search criterion; a module for the storage of information on the selected target objects; a module for selection of a background image; a control module; a data bus; an image conversion module to ensure that the user perceives said conversion as spatial movement; a memory module for background images in 2D and/or 3D format; a module for substituting 2D images for 3D images or vice versa; said control module being built so as to ensure data exchange through the data bus with the visualization module, the information input module, the target object memory module, the geographical data memory module, the module for the storage of images which are perceived by the user as the planet visual representation, the module for the storage of images which are perceived by the user as the token representation of states, the module for the storage of images which are perceived by the user as visual representations of cities, the module for the storage of images which are perceived by the user as visual representations of a city square, the module for the storage of images which are perceived by the user as visual representation of a street, the module for the storage of images which are perceived by the user as visual representation of a house, the module for filtering target objects by a search criterion, the module for the storage of information on the selected target objects, the module for selection of a background image, the image conversion module to ensure that the user perceives said conversion as spatial movement, the memory module for background images in 2D and/or 3D format, the module for substituting 2D images for 3D images or vice versa, characterized in that it includes a module for the storage of images which are perceived by the user as visual representations of hallways and/or passages; a module for the storage of images perceived by the user as visual representations of a room; a module for the storage of images perceived by the user as visual representations of an elevator cab; a user information memory module; a module for generation of images perceived by the user as token representation of a user; a module for storage of images perceived by the user as token representation of a user; a module for conversion of an image perceived by the user as token representation of a user to ensure that the user perceives such conversion as body movements of the token representation of a user; a module for identification of the user's current geographical location; a module for storage of the user's current geographical location; a payment support and control module; a module for counting the number of times the target object information was accessed; a user access level identification module; a module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square; wherein said control module is built so as to ensure data exchange through the data bus with the module for the storage of images which are perceived by the user as visual representations of hallways and/or passages, the module for the storage of images perceived by the user as visual representations of a room, the module for the storage of images perceived by the user as visual representations of an elevator cab, the user information memory module, the module for generation of images perceived by the user as token representation of a user, the module for storage of images perceived by the user as token representation of a user, the module for conversion of an image perceived by the user as token representation of a user to ensure that the user perceives such conversion as body movements of the token representation of a user, the module for identification of the user's current geographical location, the module for storage of the user's current geographical location, the payment support and control module, the module for counting the number of times the target object information was accessed, the user access level identification module, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square, as well as the visualization module, the information input module, the target object memory module, the geographical data memory module, the module for the storage of images which are perceived by the user as the planet visual representation, the module for the storage of images which are perceived by the user as the token representation of states, the module for the storage of images which are perceived by the user as visual representations of cities, the module for the storage of images which are perceived by the user as visual representations of a city square, the module for the storage of images which are perceived by the user as visual representation of a street, the module for the storage of images which are perceived by the user as visual representation of a house, the module for filtering target objects by a search criterion, the module for the storage of information on the selected target objects, the module for selection of a background image, the image conversion module to ensure that the user perceives said conversion as spatial movement, the memory module for background images in 2D and/or 3D format, the module for substituting 2D images for 3D images or vice versa, and processing of said information by means of said modules.

### BRIEF DESCRIPTION OF THE DRAWINGS

The utility model is explained by a drawing wherein a diagram of the device is displayed.

### EMBODIMENT OF THE INVENTION

The FIGURE shows: the visualization module 1, the information input module 2, the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of a city square 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30.

The visualization module 1 is an output electronic device designed to display images and information. The visualization module 1 is built so as to enable display of the information fed through the information input module 2 and the information stored in the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of a city square 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image contains a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30 and any other information. The source information can be stored as graphic file types, e.g. .tiff, jpg, .bmc, and others. Auxiliary devices such as character generators and similar can be used to visualize the information. A display, a monitor, a screen or any other visualization device can be used as the visualization module 1.

The information input module 2 is a device built to ensure input of the information that is presented as numeric and alphabetic characters and combinations of the same that present a variety of commands for the following, including the following modules: the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of city squares 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image contains a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30.

The target object memory module 3 is built so as to store the information on the target objects, including, e.g. their names, company types, activities, exterior and interior views of the premises wherein said target object is located, address of the own website of the target object, its geographical location data, information on whether said object is real or fictional, and any other information.

Target objects are defined in this application as the objects which are the target of a search. Target objects may include companies, organizations, restaurants, coffee shops, stores, information services, show rooms, museums, as well as clubs of interest where users can engage in virtual or real-life communication with each other, and any other objects of interest to users. Said target objects can also be real or fictional. Real target objects are defined in this application as the target objects that have real-life geographical positioning data and which the user can access in real life. Fictional target objects are defined in this application as the target objects that have no real-life geographical positioning data or target objects that exists within the web only and have positioning data assigned by a computer system or relevant modules.

The geographical data memory module 4 is built so as to store the geographical location data of the target objects. Such geographical location data include a planet, a continent, a country, a city, a street, a square, an alley, a house, longitude and latitude and other values that serve to locate said target object in a real or fictional geographical space.

The module for the storage of images which are perceived by the user as the planet visual representation 5 is built so as to store the images that may be perceived by the user as visual representation of a planet. Said image perceived by the user as visual representation of a planet may be, in particular, a real or token representation as a sphere containing real or token representations of waterways and continents and other peripherals:

The module for the storage of images which are perceived by the user as the token representation of states 6 is built so as to store the images that may be perceived by the user as token representation of a state. Said image perceived by the user as token representation of a state may appear as, for instance, a visual representation of geometrical figure outlines shown in different colors or brightly contoured on the map to distinguish one state from another, or by any other means.

The module for the storage of images which are perceived by the user as visual representations of cities 7 is built so as to store the images that may be perceived by the user as token representation of a city. For the purpose of this application and for convenience any settlement is a city, including localities having no city status. The image perceived by the user as visual representation of a city may appear as a token representation in the shape of a geometrical figure or an image containing a set of streets, squares and other elements characteristic of human settlement.

The module for the storage of images which are perceived by the user as visual representations of a city square 8 is built so as to store the images that may be perceived by the user as the visual representation of an urban structural element in the form of an open space surrounded by buildings, green belts or other urban structural elements (for example, see http://dic.academic.ru/dic.nsf/enc3p/236222 for a definition of a square as an urban development element).

The module for the storage of images which are perceived by the user as visual representation of a street 9 is built so as to store the images that may be perceived by the user as visual representation of an urban structural element in the form of a space confined on two sides by buildings, green belts or other urban structural elements (for example, see http://dic.academic.ru/dic.nsf/ushakov/1066678 for a definition of a street).

The module for the storage of images which are perceived by the user as visual representation of a house 10 is built so as to store the images that may be perceived by the user as visual representation of a house as structure. For the purpose of this application and for convenience a house is construed to include all and any buildings and architectural structures.

The module for the storage of images which are perceived by the user as visual representations of hallways and/or passages 11 is built so as to store the images that may be perceived by the user as visual representation of common premise used to provide passage between the rooms located on the same floor, i.e. the level above the foundation, e.g. a room with a quantity of doors to provide entrance to a variety of rooms.

The module for the storage of images perceived by the user as visual representations of a room 12 is built so as to store the images that may be perceived by the user as visual representations of individual premises, rooms or halls. Each such room may be assigned more than one image perceived by the user as visual representation of a room.

The module for the storage of images perceived by the user as visual representations of an elevator cab 13 is built so as to store the images that may be perceived by the user as visual representation of a small room with an interior characteristic of that of an elevator cab, in particular, regarding a specific control panel.

The user information memory module 14 is built so as to store information on the users, in particular, their first and last names, nationality, residence, interests and the user-defined usernames and passwords to access the system.

The module for generation of images perceived by the user as token representation of a user 15 is built so as to store a quantity of various elements (a body outline, clothing, face images, etc) combined to appear as a representation of a user, i.e. an image perceived by the user as a token representation of a user.

The module for storage of images perceived by the user as token representation of a user 16 is built so as to store an image generated by the module for generation of images perceived by the user as token representation of a user.

The module for conversion of an image perceived by the user as token representation of a user to ensure that the user perceives such conversion as body movements of the token representation of a user 17 is built so as to convert an image perceived by the user as token representation of a user to ensure that the user perceives the converted image as body movements of the token representation of a user. This includes, in particular, arm, knee or torso bending during walking, stooping, turning and other body movements.

The image conversion module to ensure that the user perceives said conversion as spatial movement 18 is built so as to convert an image, in particular, a background image and/or target object images which may be perceived by the user as zooming in or out or performing other spatial movements. For instance, in case of zooming in to a target object said image conversion module to ensure that the user perceives said conversion as spatial movement 18 is built so as to zoom in the original image (the background image and target object images) and remove (crop) the unnecessary parts of the original image from the field of view.

The module for filtering target objects by a search criterion 19 is built so as to enable selection of the relevant information (e.g. entered using the input module or selected from the saved list) from the target object information stored in the target object memory module 3. In particular, the module for filtering target objects by a search criterion 19 filters the information on target objects using associative criteria in respect to the user-defined criterion. Associative criteria are formulated in accordance with the settings pre-defined by the network administrator.

The module for the storage of information on the selected target objects 20 is built so as to enable saving of a list of target objects filtered by the module for filtering target objects by a search criterion 19. The storage time span can be pre-defined by the administrators.

The memory module for background images in 2D and/or 3D format 21 is built so as to store background images rendered as complete background images or a set of basic elements for compiling a background image (images perceived by the user as visual representations of a planet; images perceived by the user as token representations of a state; images perceived by the user as visual representations of a city; images perceived by the user as visual representations of a city square; images perceived by the user as visual representations of a street; images perceived by the user as visual representations of a house; images perceived by the user as visual representations of hallways and/or passages; images perceived by the user as visual representations of a room; images perceived by the user as visual representations of an elevator cab; images perceived by the user as token representations of a user) in 2D and/or 3D format. Each complete 2D background image or each basic element for compiling a 2D background image has a corresponding complete 3D background image or a basic element for compiling a 3D background image.

The module for substituting 2D images for 3D images or vice versa 22 is built so as to substitute a complete 3D background image for a respective complete 2D background image as displayed before or so as to substitute specific 2D basic elements for respective 3D basic elements.

Visual representations corresponding to all the above modules may appear as graphical sketches or photographic images of actual cities, streets, squares, target objects, rooms or other relevant images.

Each of the above images is associated with visualization of a specific data grouping level. Each data grouping level implies visualization of the information that matches the given search criterion to a certain degree. The higher the number of the data grouping level, the higher is the degree of query match to the search criterion. For this purpose the images perceived by the user as visual representations of a planet correspond to the first data grouping level. The images perceived by the user as visual representations of a state correspond to the second data grouping level. The images perceived by the user as visual representations of cities correspond to the third data grouping level. The images perceived by the user as visual representations of squares correspond to the fourth data grouping level. The images perceived by the user as visual representations of streets correspond to the fifth data grouping level. The images perceived by the user as visual representations of houses correspond to the sixth data grouping level. The images perceived by the user as visual representations of an elevator cab correspond to the seventh data grouping level. The images perceived by the user as visual representations of hallways and/or passages correspond to the eighth data grouping level. The images perceived by the user as visual representations of rooms correspond to the ninth data grouping level.

The module for identification of the user's current geographical location 23 is built so as to locate the user's exact position (country, city, street, square, alley, house, longitude and latitude) in a real-life geographical space at a given instant.

The module for storage of the user's current geographical location 24 is built so as to store the geographical location data obtained by the module for identification of the user's current geographical location 23 for a certain time as set by the network administrators. Storage of the user's geopositioning data is required, in particular, to use the positioning data as one of the search criteria.

The payment support and control module 25 is built so as to fix payments for access to the system, for rent or purchase of rooms or target objects and all other relevant payments. The payment can be fixed automatically by the system based on the pre-defined criteria or by a specific user. The payment support and control module 25 is built to enable storage of the information on the amount of payment fixed for a specific object. The payment support and control module 25 is built so as to transfer the payments made to a specific account, to count the time left to the next payment and to compare the amount of payment made with the payment fixed. The payment support and control module 25 is built so as to memorize the information on any payments made by a specific user for access to the system, rent or purchase of an object and on the amount of payment made.

The module for counting the number of times the target object information was accessed 26 is built so as to count the number of hits on the information on each of the target objects, memorize the number counted and initiate recounts at certain pre-defined time intervals replacing the previous value memorized by the current value.

The user access level identification module 27 is built so as to identify the access level of a specific user, for instance, by comparing the username and password entered through the information input module 2 with the usernames and passwords stored in the built-in username and password memory module or by checking the payment made by the specific user or by any other way.

The module for selection of a background image 28 is built so as to enable selection of a background image, for instance, from a list displayed in a dedicated field of the visualization module or to enable selection of any target object or another structural element of an image displayed. For example, entering a specific command by means of information input module 2 or clicking on an element of an image displayed by the module for selection of a background image 28 using a button of a selection device (a computer mouse) initializes a background image selection command.

The control module 29 is built so as to control communication and data exchange through the data bus with the visualization module 1, the information input module 2, the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of a city square 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30.

For the purpose of this application a data bus shall be construed as a system bus or a computer bus, i.e. a device for data or information exchange between electronic devices, e.g. a set of conductors and/or optic fiber and/or an integral part of radio communication (for a definition of the data bus see, for example: http://ru.wikipedia.org/wiki/%D8% E8%ED%E0_%E4% E0%ED%ED%FB%F5, for a definition of a computer bus see, for example: http://dic.academic.ru/dic.nsf/enc_tech/1386/% D1%88% D0% B8% D0% BD% D0% B0#sel=).

The module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30 is built so as to generate said images to be displayed on arriving in a specific city as well as on entering the system. One of the above images to be displayed is selected in accordance with the administrator- or user-defined presets.

### INDUSTRIAL APPLICABILITY

The utility model is implemented as follows. The device is made of the visualization module 1, the information input module 2, the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of a city square 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30. Said modules are connected within the framework of the device so that all relevant signals and information could be communicated, e.g. through the system bus or by direct connection of the relevant modules or by another method ensuring that said modules are interconnected and the data is communicated between said modules. For this purpose the control module 29 ensures proper communication between said modules.

Using the information input module 2, the relevant information is entered in the target object memory module 3, the geographical data memory module 4, the module for the storage of images which are perceived by the user as the planet visual representation 5, the module for the storage of images which are perceived by the user as the token representation of states 6, the module for the storage of images which are perceived by the user as visual representations of cities 7, the module for the storage of images which are perceived by the user as visual representations of a city square 8, the module for the storage of images which are perceived by the user as visual representation of a street 9, the module for the storage of images which are perceived by the user as visual representation of a house 10, the module for the storage of images which are perceived by the user as visual representations of hallways and/or passages 11, the module for the storage of images perceived by the user as visual representations of a room 12, the module for the storage of images perceived by the user as visual representations of an elevator cab 13, the user information memory module 14, the module for generation of images perceived by the user as token representation of a user 15, the module for storage of images perceived by the user as token representation of a user 16, the module for conversion of an image perceived by the user as token representation of a user to ensure that the user perceives such conversion as body movements of the token representation of a user 17, the image conversion module to ensure that the user perceives said conversion as spatial movement 18, the module for filtering target objects by a search criterion 19, the module for the storage of information on the selected target objects 20, the memory module for background images in 2D and/or 3D format 21, the module for substituting 2D images for 3D images or vice versa 22, the module for identification of the user's current geographical location 23, the module for storage of the user's current geographical location 24, the payment support and control module 25, the module for counting the number of times the target object information was accessed 26, the user access level identification module 27, the module for selection of a background image 28, control module 29, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30. The initial network structure is established by the network administrators. For this purpose, network counterparts are provided for the actual continents, countries and cities. Names are given to fictional continents, countries and cities. The relationship of said structural elements is then determined.

A user who needs to publish or find some information registers in the network. For this purpose, the user enters all required user data in the user information memory module 14 by the information input module 2. Said user is then automatically given a username and a password to access the system, if required. In a particular case, the user makes a required payment, the information on the payment amount provided, if necessary, by the payment support and control module 15. For this purpose, the payment support and control module 25 memorizes the amount paid, compares the amount paid with the fixed payment and initiates countdown to the next payment date.

Having registered in the network and/or having made the payment as required, the user is then entitled to access the network as defined by the user access level identification module.

The user utilizes the module for generation of images perceived by the user as token representation of a user 15 to create a token representation of the user (character). For this purpose the user selects suitable fragments from the bank of fragments in the memory of this module (e.g. body outline, clothes, etc) or uploads own images (e.g. facial images). The user-created image perceived by the user as a token representation of the user is then stored in the module for storage of images perceived by the user as token representation of a user 16 upon entering a specific command via the information input module 2. For this purpose said image perceived by the user as a token representation of the user is tethered to the user profile stored in the user information memory module 14 or to the username and password assigned.

The image perceived by the user as a token representation of the user may be utilized as a primary computer mouse cursor icon or as an additional (auxiliary) mouse cursor icon to move along the background image in accordance with the trajectory defined by the primary computer mouse cursor with a standard icon.

The user is authorized to search a target object by entering a specific search criterion. For this purpose, the user utilizes the information input module 2 to enter a search criterion or to select an attribute from the list supplied by the module for filtering target objects by a search criterion 19. The module for filtering target objects by a search criterion 19 compares the information on target objects stored in the target object memory module 3 with the criterion entered and associative search criteria. Filtered target objects are then saved in the module for the storage of information on the selected target objects 20.

In a particular case, filtered target objects are displayed as an image perceived by the user as visual representation of a planet selected from the module for the storage of images which are perceived by the user as the planet visual representation 5. Said image perceived by the user as visual representation of a planet can contain images perceived by the user as token representations of states.

The user manipulates the computer mouse represented on the screen as cursor to select one of the images perceived by the user as token representation of states. The background image is replaced by the image perceived as token representation of a state selected from the module for the storage of images which are perceived by the user as the token representation of states 6. Said image perceived by the user as visual representation of a state can contain images perceived by the user as visual representations of cities.

The user manipulates the computer mouse represented on the screen as cursor to select one of the images perceived by the user as visual representation of cities. The background image is replaced by the image perceived as visual representation of a city selected from the module for the storage of images which are perceived by the user as visual representations of cities 7. Said image perceived by the user as visual representation of a city can contain images perceived by the user as visual representations of city squares, images perceived by the user as visual representations of streets, images perceived by the user as visual representations of houses.

The user manipulates the computer mouse represented on the screen as cursor to select one of the images perceived by the user as visual representation of a city square. The background image is replaced by the image perceived as visual representation of a city square selected from the module for the storage of images which are perceived by the user as visual representations of city squares 8. Said image perceived by the user as visual representation of a city square can contain images perceived by the user as visual representations of streets, images perceived by the user as visual representations of houses.

The user manipulates the computer mouse represented on the screen as cursor to select one of the images perceived by the user as visual representation of a street. The background image is replaced by the image perceived as visual representation of a street selected from the module for the storage of images which are perceived by the user as visual representation of a street 9. Said image perceived by the user as visual representation of a street can contain images perceived by the user as visual representations of city squares, images perceived by the user as visual representations of houses.

The user manipulates the computer mouse represented on the screen as cursor to select one of the images perceived by the user as visual representation of a house. The background image is replaced by the image perceived as visual representation of a house selected from the module for the storage of images which are perceived by the user as visual representation of a house 10. Said image perceived by the user as visual representation of a house can contain images perceived by the user as visual representations of city squares, images perceived by the user as visual representations of a street.

The user manipulates the computer mouse represented on the screen as cursor to select one of the images perceived by the user as visual representation of a house. The background image is replaced by the image perceived as visual representation of an elevator cab selected from the module for the storage of images perceived by the user as visual representations of an elevator cab 13. The image perceived by the user as visual representation of an elevator cab may contain an interposed image of an elevator control panel (e.g. a list of floors in a house accompanied by a theme of each floor), i.e. a dedicated field which appears as representation of the module for selection of a background image.

The user manipulates the computer mouse represented on the screen as cursor to select a floor from the list on the elevator control panel. The background image is replaced by one of the images perceived by the user as token representation of hallways and/or passaged selected from the module for the storage of images which are perceived by the user as visual representations of hallways and/or passages 11. The image perceived by the user as token representation of hallways and/or passages may contain images perceived by the user as visual representation of rooms or images of entrance doors to such rooms.

The image of each door is interposed with the image block containing information on the target object located in the room behind this door, e.g. a company name. As the user selects one of said doors, the background image is replaced by an image perceived by the user as visual representation of a room selected from the module for the storage of images perceived by the user as visual representations of a room 12. In a particular case, the image perceived by the user as visual representation of a room may appear as a photograph of an actual room or a fictional room offered for sale or rent or as a redirect to the company website.

The user utilizes the module for substituting 2D images for 3D images or vice versa to choose a format for displaying the background image and/or target object images. For this purpose a 2D image is substituted for a 3D image or vice versa as selected from the images stored in the memory module for background images in 2D and/or 3D format 21.

The module for counting the number of times the target object information was accessed 26 counts the number of user requests to the information on each target object stored in the target object memory module 3. The target object information for a specific street is categorized by topics of interest, e.g. cinema, in accordance with the number of requests to the information on selected target objects. The information on target objects for a given street is positioned, for example, starting from the image of the central city square to the margins of the image in a descending order, i.e. the less the number of requests to the information on the target objects, the farther from the center it appears.

The user has an option to find the target objects closest to his/her current location. For this purpose, the module for identification of the user's current geographical location 23 is initialized to determine the user's location and store the geopositioning data in the module for storage of the user's current geographical location 24.

Said geopositioning data is then used as an additional search criterion to filter target objects.

The module for conversion of an image perceived by the user as token representation of a user to ensure that the user perceives such conversion as body movements of the token representation of a user 17 converts token representations of a user in such a way to ensure that the user perceives such conversion as body movements of the token representation of a user.

The image conversion module to ensure that the user perceives said conversion as spatial movement 18 serves to zoom in or out or to otherwise convert an image so that the user perceives such conversion as spatial movement.

The module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square 30 serves to display one of said images in accordance with administrator- or user-defined presets.

Therefore, implementation of the device by composing the same of the module for the storage of images which are perceived by the user as visual representations of hallways and/or passages; the module for the storage of images perceived by the user as visual representations of a room; the module for the storage of images perceived by the user as visual representations of an elevator cab; the user information memory module; the module for generation of images perceived by the user as token representation of a user; the module for storage of images perceived by the user as token representation of a user; the module for conversion of an image perceived by the user as token representation of a user to ensure that the user perceives such conversion as body movements of the token representation of a user; the module for identification of the user's current geographical location; the module for storage of the user's current geographical location; the payment support and control module; the module for counting the number of times the target object information was accessed; the user access level identification module; the module for generation of an image to be displayed wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square; as well as the visualization module; the information input module; the target object memory module; the geographical data memory module; the module for the storage of images which are perceived by the user as the planet visual representation; the module for the storage of images which are perceived by the user as the token representation of states; the module for the storage of images which are perceived by the user as visual representations of cities; the module for the storage of images which are perceived by the user as visual representations of city squares; the module for the storage of images which are perceived by the user as visual representation of a street; the module for the storage of images which are perceived by the user as visual representation of a house; the module for filtering target objects by a search criterion; the module for the storage of information on the selected target objects; the module for selection of a background image; the image conversion module to ensure that the user perceives said conversion as spatial movement; the memory module for background images in 2D and/or 3D format; the module for substituting 2D images for 3D images or vice versa facilitates increase in information search rate by way of information release at each instance by displaying the information in accordance with a specific data grouping level and by limiting the amount of information to be processed by the system without loss of search quality.

1. Information search device comprising a visualization module; an information input module; a target object memory module; a geographical data memory module; a module for the storage of images which are perceived by the user as the planet visual representation; a module for the storage of images which are perceived by the user as the token representation of states; a module for the storage of images which are perceived by the user as visual representations of cities; a module for the storage of images which are perceived by the user as visual representations of a city square; a module for the storage of images which are perceived by the user as visual representation of a street; a module for the storage of images which are perceived by the user as visual representation of a house; a module for filtering target objects by a search criterion; a module for the storage of information on the selected target objects; a module for selection of a background image; a control module; a data bus; an image conversion module to ensure that the user perceives said conversion as spatial movement; a memory module for background images in 2D and/or 3D format; a module for substituting 2D images for 3D images or vice versa; said control module being built so as to ensure data exchange through the data bus with the visualization module, the information input module, the target object memory module, the geographical data memory module, the module for the storage of images which are perceived by the user as the planet visual representation, the module for the storage of images which are perceived by the user as the token representation of states, the module for the storage of images which are perceived by the user as visual representations of cities, the module for the storage of images which are perceived by the user as visual representations of a city square, the module for the storage of images which are perceived by the user as visual representation of a street, the module for the storage of images which are perceived by the user as visual representation of a house, the module for filtering target objects by a search criterion, the module for the storage of information on the selected target objects, the module for selection of a background image, the image conversion module to ensure that the user perceives said conversion as spatial movement, the memory module for background images in 2D and/or 3D format, the module for substituting 2D images for 3D images or vice versa, characterized in that it includes a module for the storage of images which are perceived by the user as visual representations of hallways and/or passages; a module for the storage of images perceived by the user as visual representations of a room; a module for the storage of images perceived by the user as visual representations of an elevator cab; a user information memory module; a module for generation of images perceived by the user as token representation of a user; a module for storage of images perceived by the user as token representation of a user; a module for conversion of an image perceived by the user as token representation of a user to ensure that the user perceives such conversion as body movements of the token representation of a user; a module for identification of the user's current geographical location; a module for storage of the user's current geographical location; a payment support and control module; a module for counting the number of times the target object information was accessed; a user access level identification module; a module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square; wherein said control module is built so as to ensure data exchange through the data bus with the module for the storage of images which are perceived by the user as visual representations of hallways and/or passages, the module for the storage of images perceived by the user as visual representations of a room, the module for the storage of images perceived by the user as visual representations of an elevator cab, the user information memory module, the module for generation of images perceived by the user as token representation of a user, the module for storage of images perceived by the user as token representation of a user, the module for conversion of an image perceived by the user as token representation of a user to ensure that the user perceives such conversion as body movements of the token representation of a user, the module for identification of the user's current geographical location, the module for storage of the user's current geographical location, the payment support and control module, the module for counting the number of times the target object information was accessed, the user access level identification module, the module for generation of an image to be displayed, wherein such image comprises a background image and/or a target object image, said module executed so as to generate the combination of said images to match the latest visualization perceived by the user as the image of the city, or to match the user-defined location, or to match the most visited location, or to match the image of the street selected by the user from the list of streets, or to match the location selected from the city plan, or to match the image of the street selected using a search criterion, or to match the image of the city square, as well as the visualization module, the information input module, the target object memory module, the geographical data memory module, the module for the storage of images which are perceived by the user as the planet visual representation, the module for the storage of images which are perceived by the user as the token representation of states, the module for the storage of images which are perceived by the user as visual representations of cities, the module for the storage of images which are perceived by the user as visual representations of a city square, the module for the storage of images which are perceived by the user as visual representation of a street, the module for the storage of images which are perceived by the user as visual representation of a house, the module for filtering target objects by a search criterion, the module for the storage of information on the selected target objects, the module for selection of a background image, the image conversion module to ensure that the user perceives said conversion as spatial movement, the memory module for background images in 2D and/or 3D format, the module for substituting 2D images for 3D images or vice versa, and processing of said information by means of said modules.
